(19) United States
(12) Patent Application Publication
(10) Pub. No.: US 2026/0126633 A1
(43) Pub. Date: May 7, 2026

(54) IMAGING OPTICAL SYSTEM, PROJECTION TYPE DISPLAY DEVICE, AND IMAGING APPARATUS

(71) Applicant: FUJIFILM Corporation, Tokyo (JP)

(72) Inventor: Masaru AMANO, Saitama-shi (JP)

(73) Assignee: FUJIFILM Corporation, Tokyo (JP)

(21) Appl. No.: 19/438,083

(22) Filed: Dec. 31, 2025

Related U.S. Application Data
(63) Continuation of application No. PCT/JP2024/025318, filed on Jul. 12, 2024.

(30) Foreign Application Priority Data
Jul. 14, 2023 (JP) 2023-116335

(51) Int. Cl. G02B 17/08

(52) U.S. Cl. CPC G02B 17/086

(57) ABSTRACT

An imaging optical system including of a first optical system and a second optical system along an optical path in order from a magnification side to a reduction side, wherein: an intermediate image is formed at least twice between a magnification-side imaging plane and a reduction-side imaging plane, the first optical system includes at least two reflective surfaces having curvature, a surface of the first optical system on a most magnification side along the optical path is a first refractive surface that refracts rays reflected from the reflective surface of the first optical system, and a surface of the first optical system on a most reduction side along the optical path is a surface on the most reduction side along the optical path among surfaces through which rays pass plural times.

### CROSS REFERENCE TO RELATED APPLICATIONS

This application is a continuation of International Application No. PCT/JP2024/025318, filed on Jul. 12, 2024, which claims priority from Japanese Patent Application No. 2023-116335, filed on Jul. 14, 2023. The entire disclosure of each of the above applications is incorporated herein by reference.

### BACKGROUND

### Technical Field

The present disclosed technology relates to an imaging optical system, a projection type display device, and an imaging apparatus.

### Related Art

In the related art, as an imaging optical system that can be used in a projection type display device, an imaging apparatus, and the like, an imaging optical system disclosed in JP2008-250296A, JP2017-040849A, and JP2020-024359A is known.

In recent years, there is a demand for an imaging optical system that is configured to be small with a small number of optical elements and that has a wide angle of view and favorable optical performance.

### SUMMARY

The present disclosure has been made in view of the above circumstances, and provides an imaging optical system that is configured to be small with a small number of optical elements and that has a wide angle of view and favorable optical performance, and a projection type display device and an imaging apparatus comprising the imaging optical system.

A first aspect of the present disclosure relates to an imaging optical system consisting of a first optical system and a second optical system along an optical path in order from a magnification side to a reduction side, in which an intermediate image is formed at least twice between a magnification-side imaging plane and a reduction-side imaging plane, the first optical system includes at least two reflective surfaces having curvature, a surface of the first optical system on a most magnification side along the optical path is a first refractive surface that refracts rays reflected from the reflective surface of the first optical system, and a surface of the first optical system on a most reduction side along the optical path is a surface on the most reduction side along the optical path among surfaces through which rays pass a plurality of times.

In the first aspect, in a case where a distance on an optical axis from the first refractive surface to a reflective surface of the first optical system on the most magnification side along the optical path is denoted by L1, and a distance on the optical axis from the reflective surface of the first optical system on the most magnification side along the optical path to a surface of the second optical system on the most reduction side along the optical path is denoted by L2, Conditional Expression (1) is satisfied,

$$0.1 < \vert L 1 / L 2 \vert < 0.8 . \qquad ( 1 )$$

It is more preferable that Conditional Expression (1-1) is satisfied,

$$0.2 < \vert L 1 / L 2 \vert < 0.7 . \qquad ( 1 ‐ 1 )$$

In the first aspect, in a case where a distance on the optical axis from the first refractive surface to a reflective surface of the first optical system on the most reduction side along the optical path is denoted by L3, and a distance on the optical axis from the reflective surface of the first optical system on the most reduction side along the optical path to a surface of the second optical system on the most reduction side along the optical path is denoted by L4, Conditional Expression (2) is satisfied,

$$0 \text{.1} < \vert L 3 / L 4 \vert < 0.8 . \qquad ( 2 )$$

It is more preferable that Conditional Expression (2-1) is satisfied,

$$0.2 < \vert L 3 / L 4 \vert < 0.7 . \qquad ( 2 ‐ 1 )$$

In the first aspect, it is preferable that, inside the first optical system, rays are reflected three times from the reflective surface having curvature.

In the first aspect, it is preferable that the reflective surface of the first optical system on the most magnification side along the optical path and the reflective surface of the first optical system on the most reduction side along the optical path have a concave shape.

In the first aspect, it is preferable that the intermediate image is formed twice inside the first optical system.

In the first aspect, it is preferable that the first refractive surface has a free curved surface shape.

In the first aspect, it is preferable that the imaging optical system includes a display element or an imaging element disposed on the reduction-side imaging plane, in which at least one of an optical axis of the first optical system or an optical axis of the second optical system is shifted in a direction orthogonal to the optical axis with respect to a center of the display element or the imaging element.

In the first aspect, it is preferable that the optical axis of the first optical system is shifted in the direction orthogonal to the optical axis with respect to each of the optical axis of the second optical system and the center of the display element or the imaging element, and the optical axis of the second optical system is shifted in the direction orthogonal to the optical axis with respect to the center of the display element or the imaging element.

In the first aspect, it is preferable that the first refractive surface transmits the rays twice.

In the first aspect, it is preferable that the first refractive surface and one of the reflective surfaces are formed on the same optical member.

In the first aspect, it is preferable that the first optical system consists of one optical member.

In the first aspect, it is preferable that the optical member includes the first refractive surface that transmits rays twice and reflects rays once, and a surface facing the first refractive surface and that reflects rays twice.

In the first aspect, it is preferable that the reflective surface of the first optical system on the most magnification side along the optical path and the reflective surface of the first optical system on the most reduction side along the optical path are formed on the same surface.

A second aspect of the present disclosure relates to an imaging optical system, in which an optical member disposed on a most magnification side along an optical path, an intermediate image is formed at least twice between a magnification-side imaging plane and a reduction-side imaging plane, and the optical member includes a PA surface that is a surface on the most magnification side along the optical path and that transmits rays twice and reflects rays once, and a PB surface that is a surface facing the PA surface and that reflects rays twice.

In the second aspect, it is preferable that the intermediate image is formed twice inside the optical member.

A third aspect of the present disclosure relates to a projection type display device comprising the imaging optical system according to the first aspect or the second aspect.

A fourth aspect of the present disclosure relates to an imaging apparatus comprising the imaging optical system according to the first aspect or the second aspect.

In the present specification, it should be noted that “consisting of” and “consists of” represents that not only the above-described components but also lenses substantially having no refractive powers, optical elements other than lenses, such as a stop, a mask, a filter, a cover glass, a planar mirror, and a prism, and mechanism parts such as a lens flange, a lens barrel, an imaging element, and a camera shaking correction mechanism may be included.

The term “ray” in the present specification refers to a ray used for imaging on the magnification-side imaging plane or the reduction-side imaging plane. The term “reflective surface on the most magnification side along the optical path” is intended to refer to a reflective surface on the most magnification side along the optical path among all the reflective surfaces of the optical system. The term “reflective surface on the most reduction side along the optical path” is intended to refer to a reflective surface on the most reduction side along the optical path among all the reflective surfaces of the optical system.

Unless otherwise specified, a sign of a refractive power and a surface shape of the aspherical surface are considered in a paraxial region. Unless otherwise noted, the expression “distance on the optical axis” used in the conditional expressions means a geometrical distance.

According to the present disclosure, it is possible to provide an imaging optical system that is configured to be small with a small number of optical elements and that has a wide angle of view and favorable optical performance, and a projection type display device and an imaging apparatus comprising the imaging optical system.

### BRIEF DESCRIPTION OF THE DRAWINGS

FIG. 1 is a cross-sectional view showing a configuration and luminous fluxes of an imaging optical system according to an embodiment corresponding to an imaging optical system according to Example 1.

FIG. 2 is a diagram for describing a shift of an optical axis.

FIG. 3 is a diagram showing a display surface.

FIG. 4 is a diagram showing a spot diagram of Example 1.

FIG. 5 is a diagram showing a distortion grid of Example 1.

FIG. 6 is a cross-sectional view showing a configuration of an imaging optical system and a luminous flux of Example 2.

FIG. 7 is a diagram showing a spot diagram of Example 2.

FIG. 8 is a diagram showing a distortion grid of Example 2.

FIG. 9 is a cross-sectional view showing a configuration of an imaging optical system and a luminous flux of Example 3.

FIG. 10 is a diagram showing a spot diagram of Example 3.

FIG. 11 is a diagram showing a distortion grid of Example 3.

FIG. 12 is a cross-sectional view showing a configuration of an imaging optical system and a luminous flux of Example 4.

FIG. 13 is a diagram showing a spot diagram of Example 4.

FIG. 14 is a diagram showing a distortion grid of Example 4.

FIG. 15 is a schematic configuration diagram showing a projection type display device according to an embodiment.

FIG. 16 is a schematic configuration diagram showing a projection type display device according to another embodiment.

FIG. 17 is a schematic configuration diagram showing a projection type display device according to still another embodiment.

FIG. 18 is a perspective view of a front surface side of an imaging apparatus according to one embodiment.

FIG. 19 is a perspective view of a rear surface side of the imaging apparatus according to one embodiment.

### DETAILED DESCRIPTION

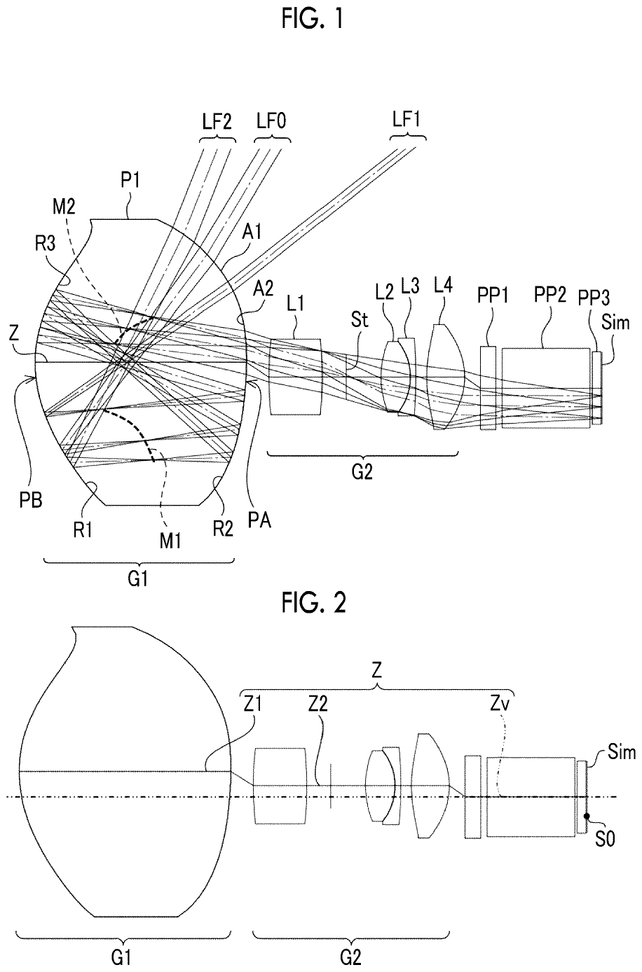

Hereinafter, an example of an embodiment according to the technology of the present disclosure will be described in detail with reference to the drawings. FIG. 1 shows a cross-sectional view showing a configuration and luminous fluxes of an imaging optical system according to an embodiment of the present disclosure. The configuration example shown in FIG. 1 corresponds to Example 1 described below. Luminous fluxes LF0, LF1, and LF2 are also shown in FIG. 1.

The imaging optical system according to the technology of the present disclosure can also be mounted on a projection type display device to configure a projection optical system where a display element is disposed on a reduction-side imaging plane. In addition, the imaging optical system can also be mounted on a digital camera or the like to configure an imaging optical system where an imaging element is disposed on the reduction-side imaging plane. Hereinafter, the imaging optical system according to the technology of the present disclosure in a case where the imaging optical system is used for a projection optical system will be described.

FIG. 1 shows an example in which optical members PP1 to PP3 and a display surface Sim of a light valve are disposed on a reduction side of the imaging optical system assuming that the imaging optical system is mounted on a projection type display device. The light valve is a display element that outputs an optical image, and the optical image is displayed as an image on the display surface Sim. As the light valve, for example, a liquid crystal display element or an image display element such as digital micromirror device (DMD: registered trademark) can be used. The optical members PP1 to PP3 are members assumed to be various filters, a cover glass, a color synthesis prism, and the like. The optical members PP1 to PP3 are members having no refractive power. Materials, lengths, and the number of components of the optical members PP1 to PP3 can be appropriately changed, and a configuration in which a part or all of the optical members PP1 to PP3 are omitted is also possible.

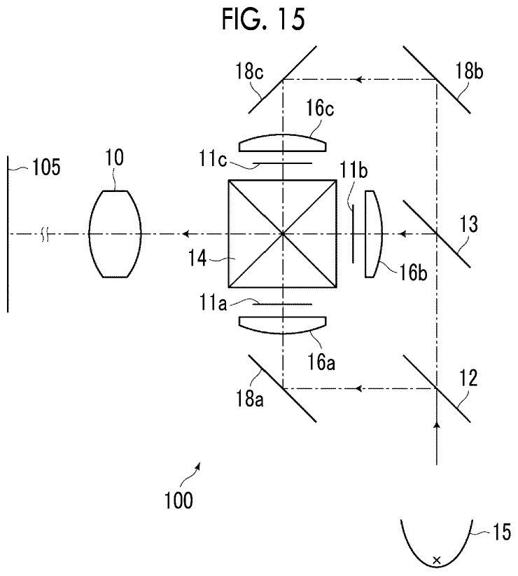

The imaging optical system is mounted on, for example, a projection type display device and projects an image displayed on the display surface Sim of the display element on the reduction side onto a projection surface on the magnification side. In the projection type display device, a luminous flux provided with image information on the display surface Sim is incident into the imaging optical system through the optical members PP1 to PP3, and is projected onto a screen (for example, refer to reference numeral 105 in FIG. 15) that is a projection surface through the imaging optical system. That is, the display surface Sim and the screen are positioned at optically conjugate positions. The screen is an example of the “magnification-side imaging plane” of the present disclosure, and the image display surface Sim is an example of the “reduction-side imaging plane” of the present disclosure. It should be noted that, in the present specification, the term “screen” means an object on which a projected image formed by the imaging optical system is projected. The screen may be, for example, not only a dedicated screen but also a wall surface of a room, a floor surface, a ceiling, an outer wall surface of a building, or the like.

In the description of the present specification, “the magnification side” refers to the screen side on the optical path, and “the reduction side” refers to the display surface Sim side on the optical path. In the present specification, “the magnification side” and “the reduction side” are determined along the optical path. For example, in the imaging optical system that forms a bent optical path, “a lens A is closer to the magnification side than a lens B” has the same meaning as “the lens A is on the optical path to be closer to the magnification side than the lens B”. Accordingly, in the imaging optical system that forms a bent optical path, “closest to the magnification side” represents that a position is closest to the magnification side in the arrangement order on the optical path, and does not represent that the position is closest to the screen in terms of distance.

The imaging optical system according to the present disclosure is configured such that at least an intermediate image is formed twice between the magnification-side imaging plane and the reduction-side imaging plane. By configuring the imaging optical system to form the intermediate image inside the optical system, the focal length of the entire system can be shortened, and a configuration suitable for wide angle of view can be obtained. In addition, by configuring the imaging optical system to form the intermediate image twice or more, it is possible to achieve wide angle of view and high performance while reducing a diameter of the optical member disposed on the most magnification side along the optical path.

It is preferable that the imaging optical system according to the present disclosure consists of a first optical system G1 and a second optical system G2 in order from the magnification side to the reduction side along the optical path as described below. As an example, the imaging optical system of FIG. 1 is configured as follows. The first optical system G1 consists of an optical member P1. The second optical system G2 consists of lens L1, an aperture stop St, and lenses L2 to L4 in order from the magnification side to the reduction side. Intermediate images M1 and M2 are formed inside the optical member P1 of the first optical system G1. The aperture stop St shown in FIG. 1 does not show the size or the shape thereof, but shows a position thereof in the optical axis Z direction. In addition, in FIG. 1, the intermediate images M1 and M2 are conceptually shown by a broken line, and the shapes of the intermediate images M1 and M2 shown in FIG. 1 are not accurate.

It is preferable that the first optical system G1 includes at least two reflective surfaces having curvature. In general, as the imaging optical system is made wider, chromatic aberration is a problem. However, since the first optical system G1 disposed on the magnification side in the entire optical system includes the reflective surface, chromatic aberration does not occur during reflection. Therefore, chromatic aberration in the entire optical system can be reduced. In addition, by reflecting the light a plurality of times, the optical system can be configured to be compact while ensuring a necessary optical path length. Therefore, it is possible to contribute to reduction in size. In addition, by including a plurality of reflective surfaces, it is possible to suppress power of each reflective surface. Therefore, occurrence of various aberrations can be reduced, and power of each optical element can be reduced. In particular, since a burden related to aberration correction of the second optical system G2 can be reduced, the number of optical members of the second optical system G2 can be reduced, and it is possible to contribute to reduction in size.

It is preferable that a surface of the first optical system G1 on the most magnification side along the optical path is configured to refract rays reflected from the reflective surface of the first optical system G1. By adopting such a configuration, it is possible to achieve both reduction in size of the reflective surface of the first optical system G1 and correction of distortion aberration and the like that are problems in achieving wide angle. Hereinafter, a surface that is the surface of the first optical system G1 on the most magnification side along the optical path and that also has an action of refracting rays reflected from the reflective surface will be referred to as a “first refractive surface”.

Specifically, it is preferable that a surface of the first optical system G1 on the most reduction side along the optical path is a surface on the most reduction side along the optical path among surfaces through which the rays pass a plurality of times. That is, it is preferable that all optical surfaces through which the rays pass a plurality of times among optical surfaces included in the entire optical system are included in the first optical system G1, and each optical surface included in the second optical system G2 is an optical surface through which the rays pass only once.

It is preferable that the imaging optical system according to the present disclosure is configured such that the rays are reflected three times from the reflective surface having curvature inside the first optical system G1. In this case, the above-described effect of including at least two reflective surfaces having curvature in the first optical system G1 can be obtained more favorably. In a case where the rays are reflected four or more times, the reflective surface may be difficult to dispose, which may be disadvantageous for reduction in size.

As an example, in the first optical system G1 of FIG. 1, the rays are reflected three times inside the first optical system G1 from two surfaces PA and PB of the optical member P1. Specifically, the first optical system G1 is configured such that rays traveling from the magnification side to the reduction side are refracted for the first time in a region A1 of the surface PA, are reflected for the first time in a region R1 of the surface PB, are reflected for the second time in a region R2 of the surface PA, are reflected for the third time in a region R3 of the surface PB, and are refracted for the second time in a region A2 of the surface PA. The surface PA of the optical member P1 is an example of a “first refractive surface” according to the present disclosure. Hereinafter, PA will be used as a reference numeral of the first refractive surface.

It is preferable that the first refractive surface PA has a free curved surface shape. By setting the first refractive surface PA, that is, the refractive surface on the most magnification side along the optical path to have a free curved surface shape, it is easy to control an aspect ratio of an image of a reduction-side conjugate plane and an image of a magnification-side conjugate plane. In addition, by setting the first refractive surface PA to have a free curved surface shape, it is possible to achieve an advantage in correcting distortion aberration and to achieve both reduction in size and high performance.

In addition, it is preferable that the first refractive surface PA transmits the rays twice. By adopting such a configuration, it is possible to reduce time and man-hours required for relative positioning work and the like of each optical surface during manufacturing, and it is possible to contribute to cost reduction.

It is preferable that the first refractive surface PA and the reflective surface are formed on the same optical member. That is, it is preferable that the optical member including the first refractive surface PA is configured to perform at least one reflection on the first refractive surface PA or another surface. By adopting such a configuration, it is possible to suppress deterioration in performance (for example, deterioration in distortion aberration and field curvature) that may occur due to a relative positional deviation between each refractive surface and each reflective surface during manufacturing. Therefore, it is possible to achieve an advantage in securing performance. In addition, it is possible to reduce time and man-hours required for relative positioning work and the like of each optical surface during manufacturing, and it is possible to contribute to cost reduction.

It is preferable that the reflective surface of the first optical system G1 on the most magnification side along the optical path and the reflective surface of the first optical system G1 on the most reduction side along the optical path have a concave shape. By setting the reflective surface on the most magnification side along the optical path to have a concave shape having a convergence action, it is possible to reduce the size of the refractive surface on the magnification side with respect to the reflective surface while reducing the size of the reflective surface, as compared with a case where the reflective surface has a convex shape having a divergence action. In addition, by setting the reflective surface on the most reduction side along the optical path to have a concave shape, it is possible to suppress the optical system on the magnification side with respect to the reflective surface from being increased in size, and it is possible to contribute to reduction in size of the entire optical system. The surface PB of FIG. 1 is an example of a “reflective surface of the first optical system G1 on the most magnification side along the optical path” and a “reflective surface of the first optical system G1 on the most reduction side along the optical path”.

It is preferable that the reflective surface of the first optical system G1 on the most magnification side along the optical path and the reflective surface of the first optical system G1 on the most reduction side along the optical path are formed on the same surface. By configuring the imaging optical system such that the reflection is performed twice on the same surface (for example, the surface PB of FIG. 1), it is possible to suppress deterioration in performance (for example, deterioration in distortion aberration and field curvature) that may occur due to a relative positional deviation between each reflective surface during manufacturing. Therefore, it is possible to achieve an advantage in securing performance. In addition, it is possible to reduce time and man-hours required for relative positioning work and the like of each optical surface during manufacturing, and it is possible to contribute to cost reduction.

The term “same surface” means a continuous surface having a shape formed based on the same design data. The term “same design data” means that the curvature radii are the same in a case of a spherical shape, means that the aspheric expressions and the aspherical coefficients are the same in a case of an aspherical shape, and means that the free curved surface expressions and the free curved surface coefficients are the same in a case of a free curved surface shape.

As in the example of FIG. 1, in a case where the first optical system G1 consists of one optical member P1, it is possible to further suppress deterioration in performance (for example, deterioration in distortion aberration and field curvature) that may occur due to a relative positional deviation between each refractive surface and each reflective surface during manufacturing. Therefore, it is possible to achieve a greater advantage in securing performance. In addition, it is possible to reduce time and man-hours required for relative positioning work and the like of each optical surface during manufacturing, and it is possible to contribute to cost reduction.

Specifically, the optical member P1 includes the surface PA that is a surface on the most magnification side along the optical path and that transmits rays twice and reflects the rays once, and the surface PB that is a surface facing the surface PA and that reflects rays twice. By performing a total of three reflections inside the optical member P1, chromatic aberration does not occur during reflection. Therefore, chromatic aberration in the entire optical system can be reduced. In addition, by reflecting the light three times, the optical system can be configured to be compact while ensuring a necessary optical path length. Therefore, it is possible to contribute to reduction in size. In addition, by reflecting the light three times, it is possible to suppress power of each reflective surface. Therefore, occurrence of various aberrations can be reduced, and power of each optical element can be reduced. In addition, by performing incidence and emission of the light to and from the optical member P1 on one surface PA, it is possible to contribute to reduction in size of the optical member P1. The surface PA of the optical member P1 is an example of a “PA surface” according to the present disclosure, and the surface PB of the optical member P1 is an example of a “PB surface” according to the present disclosure.

In the example of FIG. 1, an example in which the optical member disposed on the most magnification side along the optical path is configured by one optical member P1 is shown. However, the imaging optical system according to the present disclosure is not limited to this. For example, two or more optical members may be applied instead of the one optical member P1. In addition, materials of the optical members may be a resin or glass.

In addition, in the imaging optical system of the present disclosure, it is preferable that the intermediate image is formed twice inside the first optical system. As in the example of FIG. 1, in a case where the first optical system G1 consists of one optical member P1, the imaging optical system may be configured such that two intermediate images are formed inside the optical member P1. In these cases, the above-described effect of forming at least two intermediate images between the magnification-side imaging plane and the reduction-side imaging plane can be obtained more favorably.

FIG. 2 is a diagram for describing a shift of an optical axis Z1 of the first optical system G1 and an optical axis Z2 of the second optical system G2, and corresponds to the imaging optical system of FIG. 1. A two-dot chain line optical axis Zv shown in FIG. 2 is a virtual optical axis on lens data described below. The optical axis Z shown in FIG. 1 is a summary of the optical axis Z1 of the first optical system G1, the optical axis Z2 of the second optical system G2, and the virtual optical axis Zv between the surface of the second optical system G2 on the most reduction side and the display surface Sim shown in FIG. 2.

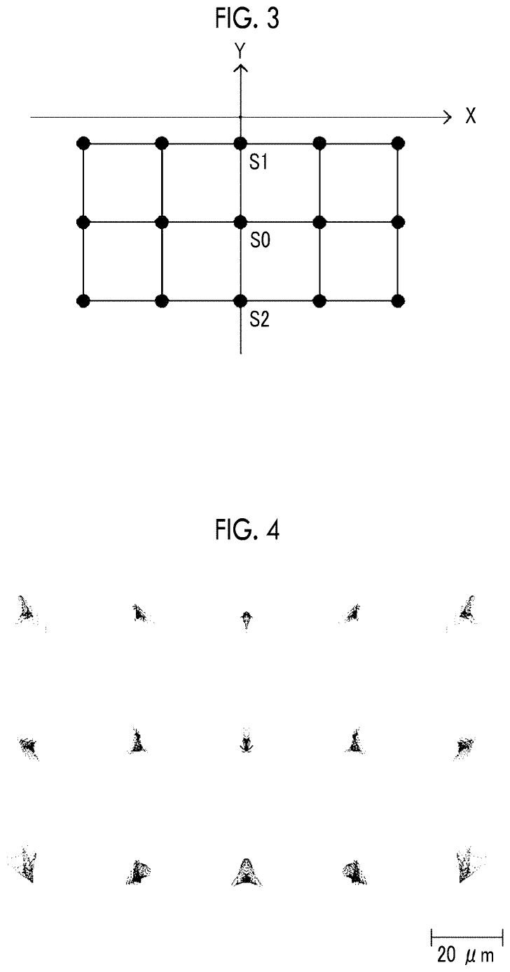

FIG. 3 shows the display surface Sim in an XY coordinate system in a case where a point through which the virtual optical axis Zv (see FIG. 2) on the lens data passes is set as an origin. In FIG. 3, the inside of the display surface Sim is divided into eight grids for convenience. A grid point S0 is a center of the display surface Sim and is shifted downward in FIGS. 2 and 3 with respect to the origin (virtual optical axis Zv). The luminous flux LF0 shown in FIG. 1 passes through the grid point S0 of FIG. 3, the luminous flux LF1 shown in FIG. 1 passes through the grid point S1 of FIG. 3, and the light flux LF2 shown in FIG. 1 passes through the grid point S2 of FIG. 3.

In the imaging optical system according to the present disclosure, it is preferable that at least one of the optical axis Z1 of the first optical system G1 or the optical axis Z2 of the second optical system G2 is shifted in a direction orthogonal to the optical axes Z1 and Z2 with respect to a center (grid point S0) of the display element disposed on the reduction-side imaging plane (display surface Sim). Specifically, it is preferable that the optical axis Z1 of the first optical system G1 is shifted in a direction orthogonal to the optical axis Z1 with respect to each of the optical axis Z2 of the second optical system G2 and the center of the display element, and the optical axis Z2 of the second optical system G2 is shifted in a direction orthogonal to the optical axis Z2 with respect to the center of the display element. That is, as shown in FIG. 2, in the imaging optical system according to the present disclosure, the optical axis Z1, the optical axis Z2, and the center (grid point S0) of the display element may be shifted from each other. In a case where the imaging optical system according to the present disclosure is used as an imaging optical system, the imaging element is disposed on the reduction-side imaging plane instead of the display element. However, the same configuration may be adopted in this case as well.

In a case where the optical axis Z2 of the second optical system G2 and the center of the display element (or the imaging element) are shifted from each other, a degree of freedom of a position of the display element (or the imaging element) in a direction orthogonal to the optical axis Z2 is improved. Therefore, it is easy to avoid interference between rays inside the optical system. In addition, in a case where the optical axis Z1 of the first optical system G1 and the optical axis Z2 of the second optical system G2 are shifted from each other, a degree of freedom of positions of the first optical system G1 and the second optical system G2 in a direction orthogonal to the optical axes Z1 and Z2 is improved in addition to the effect of avoiding the interference between the rays. Therefore, it is possible to improve design performance.

Next, preferable and possible configurations about conditional expressions of the imaging optical system according to the present disclosure will be described. In the following description relating to the conditional expressions, in order to avoid redundant description, factors having the same definition will be represented by the same symbols, and the description thereof will not be repeated. The term “optical axis” used in the conditional expression is the virtual optical axis Zv (see FIG. 2) on the lens data.

In the imaging optical system according to the present disclosure, in a case where a distance on the optical axis from the first refractive surface PA to the reflective surface of the first optical system G1 on the most magnification side along the optical path is denoted by L1, and a distance on the optical axis from the reflective surface of the first optical system G1 on the most magnification side along the optical path to the surface of the second optical system G2 on the most reduction side along the optical path is denoted by L2, it is preferable that Conditional Expression (1) is satisfied. In the example of FIG. 1, the “reflective surface of the first optical system G1 on the most magnification side along the optical path” is the surface PB, and the “surface of the second optical system G2 on the most reduction side along the optical path” is a reduction side surface of the lens L4. By ensuring that a value governed by Conditional Expression (1) does not reach or exceed its upper limit, the length L1 with respect to L2 is prevented from becoming excessively large, whereby an increase in the diameter of the first refractive surface PA (that is, the refractive surface on the most magnification side along the optical path) can be suppressed. By ensuring that a value governed by Conditional Expression (1) does not fall to or below its lower limit, the length L2 with respect to L1 is prevented from becoming excessively large, whereby an increase in the overall size of the optical system can be suppressed. In order to obtain more favorable characteristics, it is more preferable that the imaging optical system according to the present disclosure satisfies Conditional Expression (1-1).

$$0 \text{.1} < \vert L 1 / L 2 \vert < 0.8 \qquad ( 1 )$$

$$0.2 < \vert L 1 / L 2 \vert < 0.7 \qquad ( 1 ‐ 1 )$$

In addition, in the imaging optical system according to the present disclosure, in a case where a distance on the optical axis from the first refractive surface PA to the reflective surface of the first optical system G1 on the most reduction side along the optical path is denoted by L3, and a distance on the optical axis from the reflective surface of the first optical system G1 on the most reduction side along the optical path to the surface of the second optical system G2 on the most reduction side along the optical path is denoted by L4, it is preferable that Conditional Expression (2) is satisfied. In the example of FIG. 1, the “reflective surface of the first optical system G1 on the most reduction side along the optical path” is the surface PB. By ensuring that a value governed by Conditional Expression (2) does not reach or exceed its upper limit, the length of L3 with respect to L4 is prevented from becoming excessively large, whereby an increase in the diameter of the first refractive surface PA (that is, the refractive surface on the most magnification side along the optical path) can be suppressed. By ensuring that a value governed by Conditional Expression (2) does not fall to or below its lower limit, the length of L4 with respect to L3 does not become excessively large, whereby an increase in the overall size of the optical system can be suppressed. In order to obtain more favorable characteristics, it is more preferable that the imaging optical system according to the present disclosure satisfies Conditional Expression (2-1).

$$0 \text{.1} < \vert L 3 / L 4 \vert < 0.8 \qquad ( 2 )$$

$$0.2 < \vert L 3 / L 4 \vert < 0.7 \qquad ( 2 ‐ 1 )$$

The above preferable configurations and available configurations including the configurations related to the conditional expressions can be used in any combination thereof and are preferably selectively adopted, as appropriate, in accordance with required specifications. Various modifications can be made without departing from the scope of the present disclosed technology. For example, in the disclosed technology, the number of lenses and optical members included in the imaging optical system and the shapes of the lenses and the optical members may be different from those in the example of FIG. 1.

As an example, a preferred aspect of the imaging optical system according to the present disclosure consists of a first optical system G1 and a second optical system G2 along an optical path in order from a magnification side to a reduction side, in which an intermediate image is formed at least twice between a magnification-side imaging plane and a reduction-side imaging plane, the first optical system G1 includes at least two reflective surfaces having curvature, a surface of the first optical system G1 on a most magnification side along the optical path is a first refractive surface PA that refracts rays reflected from the reflective surface of the first optical system G1, and a surface of the first optical system G1 on a most reduction side along the optical path is a surface on the most reduction side along the optical path among surfaces through which rays pass a plurality of times.

In addition, another preferred aspect of the imaging optical system according to the present disclosure includes an optical member P1 disposed on a most magnification side along an optical path, an intermediate image is formed at least twice between a magnification-side imaging plane and a reduction-side imaging plane, and the optical member includes a PA surface that is a surface on the most magnification side along the optical path and that transmits rays twice and reflects rays once, and a PB surface that is a surface facing the PA surface and that reflects rays twice.

Next, examples of the imaging optical system of the present disclosure will be described, with reference to the drawings. Reference numerals provided in the cross-sectional view of each example are independently used for each example in order to avoid complication of description and the drawings caused by an increase in the number of digits of the reference numerals. Accordingly, a common reference numeral provided in the drawings of different examples does not necessarily indicate a common configuration. Hereinafter, the term “optical axis” in the description of each example means the virtual optical axis Zv on the lens data (see FIG. 2).

### Example 1

FIG. 1 is a cross-sectional view of a configuration and luminous fluxes of an imaging optical system of Example 1, and an illustration method and a configuration thereof are as described above. Therefore, some description is not repeated herein. The imaging optical system according to Example 1 consists of a first optical system G1 and a second optical system G2 along the optical path in order from the magnification side to the reduction side. The first optical system G1 consists of an optical member P1. The optical member P1 of Example 1 is a resin lens. The second optical system G2 consists of lens L1, an aperture stop St, and lenses L2 to L4 in order from the magnification side to the reduction side. Intermediate images M1 and M2 are formed inside the optical member P1 of the first optical system G1.

The first optical system G1 and the second optical system G2 are respectively shifted in a direction orthogonal to the optical axis. A shift amount with respect to the virtual optical axis Zv in a case where an upper side in FIG. 2 is a positive direction and a lower side is a negative direction is as follows. The first optical system G1 is 3.3223 millimeters (mm) in the positive direction, and the second optical system G2 is 1.4537 millimeters (mm).

As shown in FIG. 3, the display surface Sim has a horizontally long rectangular shape, and has a size of 5.184 millimeters (mm) in a horizontal direction and 2.916 millimeters (mm) in a vertical direction. A position of a center (grid point S0) of the display surface Sim is at coordinates (X, Y)=(0, −2.45) in an XY coordinate system in which the virtual optical axis Zv is an origin (unit: millimeters (mm)).

For the imaging optical system of Example 1, basic lens data is shown in Table 1, free curved surface coefficients are shown in Tables 2A and 2B, and aspherical coefficients are shown in Table 3. The free curved surface coefficients are shown in two tables in order to avoid an increase in the length of one table.

The table of the basic lens data is described as below. The column of Sn shows surface numbers in a case where the surface closest to the magnification side is the first surface and the number is increased one by one toward the reduction side. An asterisk mark (*) is attached to the surface number of the aspherical surface, and an asterisk mark (**) is attached to the surface number of the free curved surface. The column of R indicates a curvature radius of each surface, and a paraxial curvature radius is indicated in the column of the free curved surface. The column of D shows a surface spacing between each surface and the surface adjacent to the reduction side on the optical axis Zv. The column of Nd shows a refractive index of each component with respect to a d line. The column of vd shows an Abbe number of each component with respect to the d line. The 20th surface of Table 1 corresponds to the display surface Sim. The “d line” described in the present specification is a bright line, and a wavelength of the d line is 587.56 nanometers (nm).

In the table of the basic lens data, the sign of the curvature radius of a surface that is convex to the magnification side is positive, and the sign of the curvature radius of a surface that is convex to the reduction side is negative. In the column of Sn, the terms (PA), (PB), and (St) are also described for surfaces corresponding to the first refractive surface PA, the surface PB disposed to face the first refractive surface PA, and the aperture stop St.

Values of a projection distance, an overall angle of view, and a stop diameter are shown outside the table of Table 1. The projection distance is a distance from the first refractive surface PA to the screen. The stop diameter is an opening diameter (radius) of the aperture stop St in a case where the aperture stop St is in an open state. “Reflective surface” is filled in the outside of the row corresponding to each of the reflective surfaces.

In Tables 2A and 2B, for each free curved surface, the surface number is indicated in the row of Sn, and numerical values of the free curved surface coefficients for each free curved surface are indicated in the row of C (i, j). The “E±n” (n: integer) of the numerical values of the free curved surface coefficients of Tables 2A and 2B means “×10^{±n}”. The free curved surface coefficients shown in Tables 2A and 2B are values of rotationally asymmetric free curved surface coefficients C (i, j) in a free curved surface expression represented by the following expression.

$$Z = \sum \sum C ( i , j ) \cdot {X}^{i} \cdot {Y}^{j}$$

here,
X, Y, and Z are coordinates with a surface apex as an origin.

In addition, in the expression, the value of X is an absolute value.

In addition, in the expression, the first 2 is a sum related to i, and the second Σ is a sum related to j.

Table 3 shows the surface number and the aspherical coefficient for each aspherical surface. In Table 3, the row of Sn shows surface numbers of the aspherical surfaces, and the rows of KA and Am show numerical values of the aspherical coefficients for each aspherical surface. It should be noted that m of Am is an integer equal to or more than 3, and varies depending on the surface. For example, in the twelfth surface according to Example 1, m=3, 4, 5, . . . , and 10. The “E±n” (n: integer) in numerical values of the aspherical coefficients in Table 3 indicates “×10^{±n}”. KA and Am are the aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where,
Zd: a depth of the aspherical surface (a length of a perpendicular line drawn from a point on the aspherical surface at a height h to a plane that is in contact with an aspherical surface apex and that is perpendicular to the optical axis Z),
h: a height (a distance from the optical axis Z to the lens surface),
C: a reciprocal of the paraxial curvature radius,
KA and Am: aspherical coefficients, and
Σ in the aspheric equation means a sum related to m.

In data of each table, a degree is used as a unit of an angle, and millimeter (mm) is used as a unit of a length, but appropriate different units may be used since the optical system can be used even in a case where the system is enlarged or reduced in proportion. Each table below shows numerical values rounded in a predetermined number of digits.

TABLE 1
Example 1

| Sn | R | D | Nd | νd | |
|---|---|---|---|---|---|
| **1(PA) | ∞ | −26.9994 | 1.53158 | 55.078 | |
| **2(PB) | ∞ | 26.9994 | 1.53158 | 55.078 | Reflective surface |
| **3(PA) | ∞ | −26.9994 | 1.53158 | 55.078 | Reflective surface |
| **4(PB) | ∞ | 26.9994 | 1.53158 | 55.078 | Reflective surface |
| **5(PA) | ∞ | 2.8456 | | | |
| 6 | 46.2428 | 6.8086 | 1.62004 | 36.263 | |
| 7 | −50.5621 | 3.0165 | | | |
| 8(St) | ∞ | 4.4150 | | | |
| 9 | 12.3251 | 3.7763 | 1.49700 | 81.607 | |
| 10 | −7.5464 | 0.6991 | 1.91082 | 35.253 | |
| 11 | −66.2925 | 1.3837 | | | |
| *12 | 17.6310 | 4.8433 | 1.61881 | 63.854 | |
| *13 | −8.7368 | 2.0000 | | | |
| 14 | ∞ | 2.0000 | 1.51680 | 64.197 | |
| 15 | ∞ | 0.8000 | | | |
| 16 | ∞ | 11.2000 | 1.72342 | 37.955 | |
| 17 | ∞ | 0.3000 | | | |
| 18 | ∞ | 1.1000 | 1.48749 | 70.440 | |
| 19 | ∞ | 0.1569 | | | |
| 20 | ∞ | | | | |

Projection distance (mm) 338
Overall angle of view (degree) 143
Stop diameter (mm) 2.90

TABLE 2A
Example 1

| Sn | 1, 3, 5 | 2, 4 |
|---|---|---|
| C(1, 0) | 0.00000E+00 | 0.00000E+00 |
| C(0, 1) | 1.13833E−02 | −2.14352E−05 |
| C(2, 0) | −1.15527E−02 | 2.82347E−02 |
| C(1, 1) | 0.00000E+00 | 0.00000E+00 |
| C(0, 2) | −1.20261E−02 | 2.82813E−02 |
| C(3, 0) | 0.00000E+00 | 0.00000E+00 |
| C(2, 1) | −5.73513E−04 | −9.20575E−05 |
| C(1, 2) | 0.00000E+00 | 0.00000E+00 |
| C(0, 3) | −6.61433E−04 | 1.53320E−04 |
| C(4, 0) | −1.68797E−05 | 1.25728E−05 |
| C(3, 1) | 0.00000E+00 | 0.00000E+00 |
| C(2, 2) | −9.20200E−05 | 2.99377E−05 |
| C(1, 3) | 0.00000E+00 | 0.00000E+00 |
| C(0, 4) | −5.77343E−05 | 7.70726E−06 |
| C(5, 0) | 0.00000E+00 | 0.00000E+00 |
| C(4, 1) | −5.66950E−07 | 1.89663E−06 |
| C(3, 2) | 0.00000E+00 | 0.00000E+00 |
| C(2, 3) | 2.99715E−06 | 7.24427E−07 |
| C(1, 4) | 0.00000E+00 | 0.00000E+00 |
| C(0, 5) | 1.03043E−06 | −4.39594E−07 |
| C(6, 0) | −1.39229E−07 | −9.63461E−08 |
| C(5, 1) | 0.00000E+00 | 0.00000E+00 |
| C(4, 2) | −1.25063E−07 | −4.45114E−07 |
| C(3, 3) | 0.00000E+00 | 0.00000E+00 |
| C(2, 4) | 2.61293E−07 | −2.44380E−07 |
| C(1, 5) | 0.00000E+00 | 0.00000E+00 |
| C(0, 6) | 1.18044E−07 | −6.78736E−08 |
| C(7, 0) | 0.00000E+00 | 0.00000E+00 |
| C(6, 1) | 1.10609E−08 | −1.06467E−08 |
| C(5, 2) | 0.00000E+00 | 0.00000E+00 |
| C(4, 3) | −7.17764E−09 | −5.50281E−09 |
| C(3, 4) | 0.00000E+00 | 0.00000E+00 |
| C(2, 5) | −1.24232E−08 | 4.07042E−09 |
| C(1, 6) | 0.00000E+00 | 0.00000E+00 |
| C(0, 7) | −6.92744E−10 | 3.11113E−09 |

TABLE 2B
Example 1

| Sn | 1, 3, 5 | 2, 4 |
|---|---|---|
| C(8, 0) | 6.03556E−10 | −8.17955E−10 |
| C(7, 1) | 0.00000E+00 | 0.00000E+00 |
| C(6, 2) | 7.67061E−10 | 1.80739E−09 |
| C(5, 3) | 0.00000E+00 | 0.00000E+00 |
| C(4, 4) | 1.37936E−09 | 8.36562E−10 |
| C(3, 5) | 0.00000E+00 | 0.00000E+00 |
| C(2, 6) | −2.45212E−11 | −3.35854E−10 |
| C(1, 7) | 0.00000E+00 | 0.00000E+00 |
| C(0, 8) | −3.49655E−11 | 9.09979E−11 |
| C(9, 0) | 0.00000E+00 | 0.00000E+00 |
| C(8, 1) | −6.35547E−11 | 7.88484E−11 |
| C(7, 2) | 0.00000E+00 | 0.00000E+00 |
| C(6, 3) | 2.23487E−11 | −4.52644E−11 |
| C(5, 4) | 0.00000E+00 | 0.00000E+00 |
| C(4, 5) | 2.53438E−11 | −4.21819E−11 |
| C(3, 6) | 0.00000E+00 | 0.00000E+00 |
| C(2, 7) | 1.99032E−11 | −4.15762E−11 |
| C(1, 8) | 0.00000E+00 | 0.00000E+00 |
| C(0, 9) | −1.64856E−12 | −1.29666E−11 |
| C(10, 0) | −2.17687E−13 | 7.55272E−12 |
| C(9, 1) | 0.00000E+00 | 0.00000E+00 |
| C(8, 2) | 8.00319E−13 | 2.74232E−12 |
| C(7, 3) | 0.00000E+00 | 0.00000E+00 |
| C(6, 4) | −4.91705E−12 | −3.36362E−12 |
| C(5, 5) | 0.00000E+00 | 0.00000E+00 |
| C(4, 6) | −5.92253E−12 | 3.28509E−12 |
| C(3, 7) | 0.00000E+00 | 0.00000E+00 |
| C(2, 8) | −2.31094E−12 | 2.12353E−12 |
| C(1, 9) | 0.00000E+00 | 0.00000E+00 |
| C(0, 10) | −4.50506E−13 | −2.35751E−13 |

TABLE 3
Example 1

| Sn | 12 | 13 |
|---|---|---|
| KA | 1.00000E+00 | 1.00000E+00 |
| A3 | 0.00000E+00 | 0.00000E+00 |
| A4 | −1.58832E−04 | 3.19153E−04 |
| A5 | −5.99866E−05 | −3.29306E−05 |
| A6 | 2.24642E−05 | 1.01124E−05 |
| A7 | −2.80712E−06 | −8.00563E−07 |
| A8 | −9.75641E−08 | −1.44356E−07 |
| A9 | 5.10402E−08 | 3.21416E−08 |
| A10 | −3.35194E−09 | −1.58132E−09 |

FIG. 4 shows a spot diagram in a case where ray tracing is performed from the magnification side to the reduction side in Example 1. Each spot diagram of FIG. 4 is a spot diagram at each of 15 grid points indicated by black circles on the display surface Sim of FIG. 3.

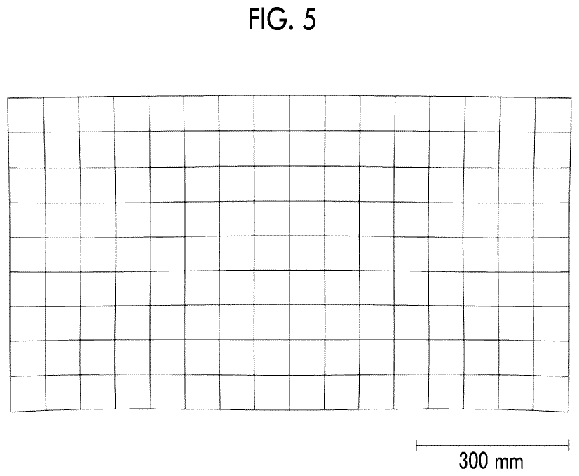

FIG. 5 shows a distortion grid of Example 1. The distortion grid indicates a distortion shape of a grid pattern formed on the screen in a case where an image consisting of a grid pattern is projected using the imaging optical system of Example 1.

Symbols, meanings, description methods, and illustration methods of the respective data pieces according to Example 1 are basically similar to those in the following examples unless otherwise specified. Therefore, hereinafter, repeated description will not be given.

### Example 2

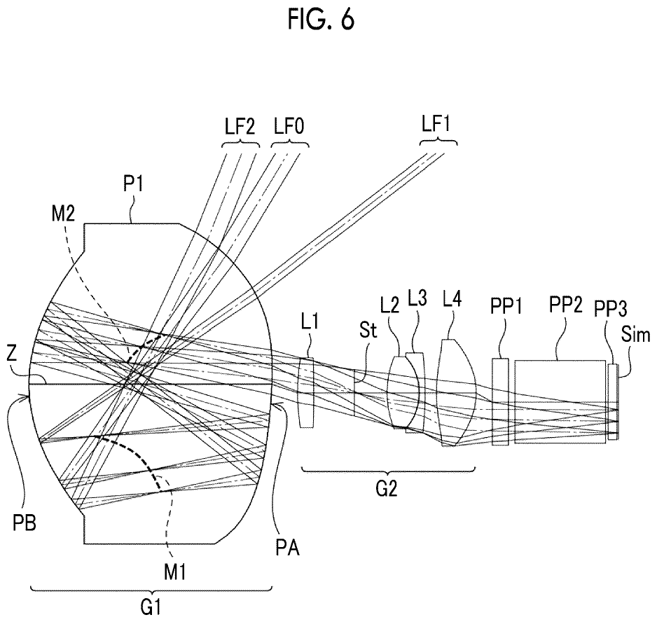

FIG. 6 shows a cross-sectional view of a configuration of the imaging optical system of Example 2 and a luminous flux. The imaging optical system according to Example 2 consists of a first optical system G1 and a second optical system G2 along the optical path in order from the magnification side to the reduction side. The first optical system G1 consists of an optical member P1. The optical member P1 of Example 2 is a glass lens. The second optical system G2 consists of lens L1, an aperture stop St, and lenses L2 to L4 in order from the magnification side to the reduction side. Intermediate images M1 and M2 are formed inside the optical member P1 of the first optical system G1.

The first optical system G1 and the second optical system G2 are respectively shifted in a direction orthogonal to the optical axis. A shift amount with respect to the virtual optical axis Zv in a case where an upper side in FIG. 2 is a positive direction and a lower side is a negative direction is as follows. The first optical system G1 is 2.2243 millimeters (mm) in the positive direction, and the second optical system G2 is 1.1443 millimeters (mm). A size of the display surface Sim and a position with respect to the virtual optical axis Zv are the same as those in Example 1.

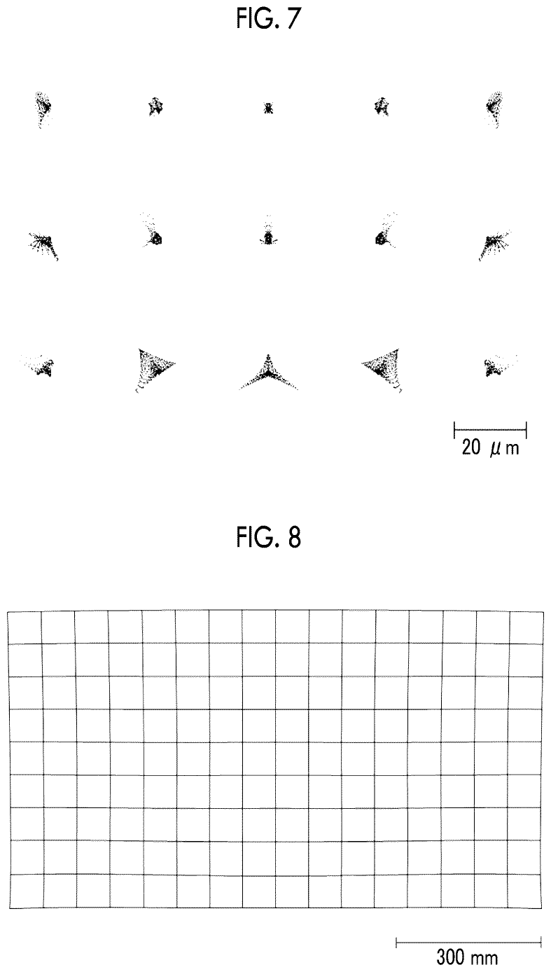

For the imaging optical system of Example 2, basic lens data is shown in Table 4, free curved surface coefficients are shown in Tables 5A and 5B, aspherical coefficients are shown in Table 6, the spot diagram is shown in FIG. 7, and the distortion grid is shown in FIG. 8.

TABLE 4
Example 2

| Sn | R | D | Nd | νd | |
|---|---|---|---|---|---|
| **1(PA) | ∞ | −30.0009 | 1.51680 | 64.197 | |
| *2(PB) | 19.4798 | 30.0009 | 1.51680 | 64.197 | Reflective surface |
| **3(PA) | ∞ | −30.0009 | 1.51680 | 64.197 | Reflective surface |
| *4(PB) | 19.4798 | 30.0009 | 1.51680 | 64.197 | Reflective surface |
| **5(PA) | ∞ | 3.1923 | | | |
| 6 | 27.4230 | 2.0080 | 1.63980 | 34.466 | |
| 7 | −111.3053 | 4.9237 | | | |
| 8(St) | ∞ | 4.0593 | | | |
| 9 | 12.0498 | 4.0010 | 1.49700 | 81.607 | |
| 10 | −6.8230 | 0.6991 | 1.91082 | 35.253 | |
| 11 | −46.6735 | 1.4141 | | | |
| *12 | 19.8348 | 4.8907 | 1.61881 | 63.854 | |
| *13 | −8.3445 | 2.0000 | | | |
| 14 | ∞ | 2.0000 | 1.51680 | 64.197 | |
| 15 | ∞ | 0.8000 | | | |
| 16 | ∞ | 11.2000 | 1.72342 | 37.955 | |
| 17 | ∞ | 0.3000 | | | |
| 18 | ∞ | 1.1000 | 1.48749 | 70.440 | |
| 19 | ∞ | 0.1839 | | | |
| 20 | ∞ | | | | |

Projection distance (mm) 335
Overall angle of view (degree) 143
Stop diameter (mm) 2.90

TABLE 5A
Example 2

| Sn | 1, 3, 5 |
|---|---|
| C(1, 0) | 0.00000E+00 |
| C(0, 1) | 3.88651E−02 |
| C(2, 0) | −6.72775E−03 |
| C(1, 1) | 0.00000E+00 |
| C(0, 2) | −8.47116E−03 |
| C(3, 0) | 0.00000E+00 |
| C(2, 1) | −5.36975E−04 |
| C(1, 2) | 0.00000E+00 |
| C(0, 3) | −6.07993E−04 |
| C(4, 0) | −3.37241E−05 |
| C(3, 1) | 0.00000E+00 |
| C(2, 2) | −1.10252E−04 |
| C(1, 3) | 0.00000E+00 |
| C(0, 4) | −4.91343E−05 |
| C(5, 0) | 0.00000E+00 |
| C(4, 1) | −2.04304E−06 |
| C(3, 2) | 0.00000E+00 |
| C(2, 3) | 8.85049E−07 |
| C(1, 4) | 0.00000E+00 |
| C(0, 5) | 8.24104E−07 |
| C(6, 0) | −6.67427E−08 |
| C(5, 1) | 0.00000E+00 |
| C(4, 2) | 9.86564E−08 |
| C(3, 3) | 0.00000E+00 |
| C(2, 4) | 3.83784E−07 |
| C(1, 5) | 0.00000E+00 |
| C(0, 6) | 7.97340E−08 |
| C(7, 0) | 0.00000E+00 |
| C(6, 1) | 9.94353E−09 |
| C(5, 2) | 0.00000E+00 |
| C(4, 3) | 1.19156E−08 |
| C(3, 4) | 0.00000E+00 |
| C(2, 5) | −1.68151E−09 |
| C(1, 6) | 0.00000E+00 |
| C(0, 7) | −1.32350E−09 |

TABLE 5B
Example 2

| Sn | 1, 3, 5 |
|---|---|
| C(8, 0) | 4.81886E−10 |
| C(7, 1) | 0.00000E+00 |
| C(6, 2) | 6.52953E−10 |
| C(5, 3) | 0.00000E+00 |
| C(4, 4) | −2.32074E−10 |
| C(3, 5) | 0.00000E+00 |
| C(2, 6) | −6.35133E−10 |
| C(1, 7) | 0.00000E+00 |
| C(0, 8) | −1.12995E−11 |
| C(9, 0) | 0.00000E+00 |
| C(8, 1) | −4.38474E−11 |
| C(7, 2) | 0.00000E+00 |
| C(6, 3) | −1.89471E−11 |
| C(5, 4) | 0.00000E+00 |
| C(4, 5) | −1.82401E−11 |
| C(3, 6) | 0.00000E+00 |
| C(2, 7) | 5.90697E−12 |
| C(1, 8) | 0.00000E+00 |
| C(0, 9) | 1.81918E−12 |
| C(10, 0) | −2.44685E−13 |
| C(9, 1) | 0.00000E+00 |
| C(8, 2) | −4.92594E−13 |
| C(7, 3) | 0.00000E+00 |
| C(6, 4) | −2.11702E−12 |
| C(5, 5) | 0.00000E+00 |
| C(4, 6) | −6.98548E−13 |
| C(3, 7) | 0.00000E+00 |
| C(2, 8) | −5.11847E−13 |
| C(1, 9) | 0.00000E+00 |
| C(0, 10) | −2.73106E−13 |

TABLE 6
Example 2

| Sn | 2, 4 | 12 | 13 |
|---|---|---|---|
| KA | 6.48794E−01 | 1.00000E+00 | 1.00000E+00 |
| A3 | 0.00000E+00 | 0.00000E+00 | 0.00000E+00 |
| A4 | −5.40043E−05 | −2.42984E−04 | 2.98390E−04 |
| A5 | 5.25646E−06 | −3.35588E−05 | −3.54680E−05 |
| A6 | 5.55960E−07 | 2.07472E−05 | 1.27599E−05 |
| A7 | −9.73748E−08 | −3.40475E−06 | −9.80077E−07 |
| A8 | −1.56116E−09 | −2.13076E−08 | −1.98996E−07 |
| A9 | 6.80606E−10 | 5.57854E−08 | 4.15436E−08 |
| A10 | −6.75717E−12 | −4.26248E−09 | −1.93370E−09 |
| A11 | −2.74771E−12 | | |
| A12 | 7.31710E−14 | | |
| A13 | 5.76277E−15 | | |
| A14 | −2.15081E−16 | | |
| A15 | −4.90669E−18 | | |
| A16 | 2.18413E−19 | | |

### Example 3

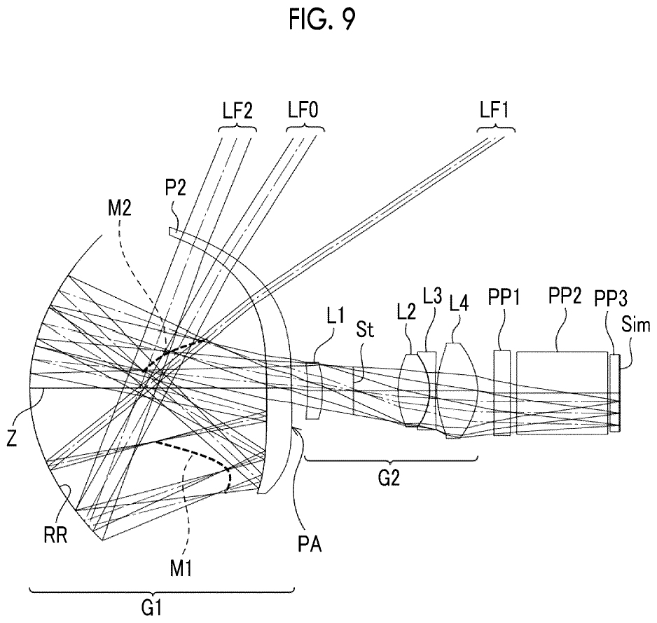

FIG. 9 shows a cross-sectional view of a configuration of the imaging optical system of Example 3 and a luminous flux. The imaging optical system according to Example 3 consists of a first optical system G1 and a second optical system G2 along the optical path in order from the magnification side to the reduction side. The first optical system G1 consists of an optical member P2 and a reflective surface RR. The second optical system G2 consists of lens L1, an aperture stop St, and lenses L2 to L4 in order from the magnification side to the reduction side. Intermediate images M1 and M2 are formed inside the first optical system G1.

The first optical system G1 and the second optical system G2 are respectively shifted in a direction orthogonal to the optical axis. A shift amount with respect to the virtual optical axis Zv in a case where an upper side in FIG. 2 is a positive direction and a lower side is a negative direction is as follows. The first optical system G1 is 0.6206 millimeters (mm) in the positive direction, and the second optical system G2 is 0.2961 millimeters (mm). A size of the display surface Sim and a position with respect to the virtual optical axis Zv are the same as those in Example 1.

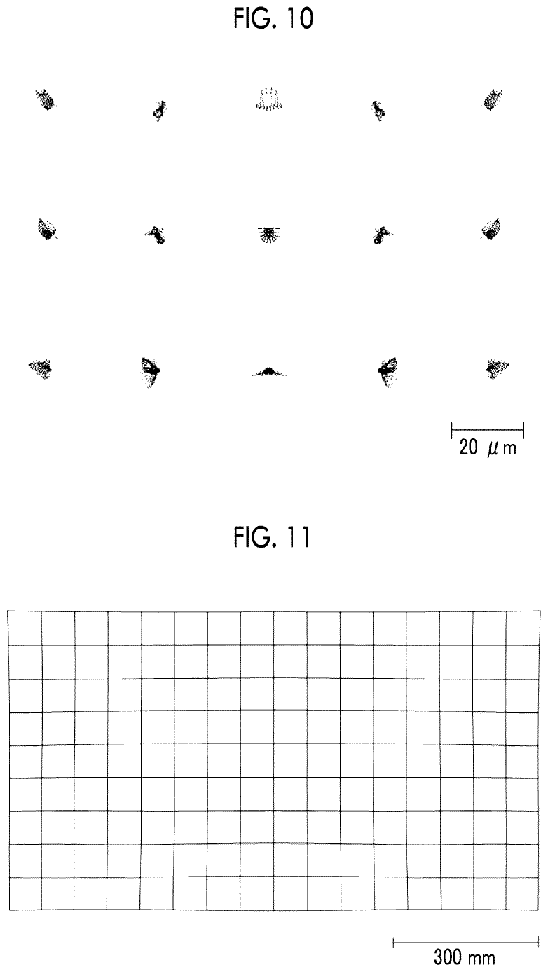

For the imaging optical system of Example 3, basic lens data is shown in Table 7, free curved surface coefficients are shown in Tables 8A and 8B, aspherical coefficients are shown in Table 9, the spot diagram is shown in FIG. 10, and the distortion grid is shown in FIG. 11.

TABLE 7
Example 3

| Sn | R | D | Nd | νd | |
|---|---|---|---|---|---|
| **1 | ∞ | −3.0789 | 1.53158 | 55.078 | |
| **2 | ∞ | −29.1222 | | | |
| *3 | 20.6251 | 29.1222 | | | Reflective surface |
| **4 | ∞ | −29.1222 | | | Reflective surface |
| *5 | 20.6251 | 29.1222 | | | Reflective surface |
| **6 | ∞ | 3.0789 | 1.53158 | 55.078 | |
| **7 | ∞ | 1.9991 | | | |
| 8 | −28.2608 | 1.8066 | 1.63980 | 34.466 | |
| 9 | −12.7343 | 3.7470 | | | |
| 10(St) | ∞ | 5.5159 | | | |
| 11 | 10.5986 | 3.8486 | 1.49700 | 81.607 | |
| 12 | −7.2892 | 0.7000 | 1.91082 | 35.253 | |
| 13 | 95.3961 | 0.1991 | | | |
| *14 | 10.9571 | 5.0211 | 1.61881 | 63.854 | |
| *15 | −7.5484 | 2.0000 | | | |
| 16 | ∞ | 2.0000 | 1.51680 | 64.197 | |
| 17 | ∞ | 0.8000 | | | |
| 18 | ∞ | 11.2000 | 1.72342 | 37.955 | |
| 19 | ∞ | 0.3000 | | | |
| 20 | ∞ | 1.1000 | 1.48749 | 70.440 | |
| 21 | ∞ | 0.1227 | | | |
| 22 | ∞ | | | | |

Projection distance (mm) 335
Overall angle of view (degree) 142
Stop diameter (mm) 2.90

TABLE 8A
Example 3

| Sn | 1, 7 | 2, 4, 6 |
|---|---|---|
| C(1, 0) | 0.00000E+00 | 0.00000E+00 |
| C(0, 1) | −1.17837E−02 | −5.20295E−03 |
| C(2, 0) | −6.66887E−04 | −1.05090E−03 |
| C(1, 1) | 0.00000E+00 | 0.00000E+00 |
| C(0, 2) | −2.00700E−03 | −3.22558E−03 |
| C(3, 0) | 0.00000E+00 | 0.00000E+00 |
| C(2, 1) | −8.25058E−04 | −7.47504E−04 |
| C(1, 2) | 0.00000E+00 | 0.00000E+00 |
| C(0, 3) | −7.83867E−04 | −6.11768E−04 |
| C(4, 0) | −1.18594E−04 | −3.13511E−05 |
| C(3, 1) | 0.00000E+00 | 0.00000E+00 |
| C(2, 2) | −3.14097E−04 | −1.72911E−04 |
| C(1, 3) | 0.00000E+00 | 0.00000E+00 |
| C(0, 4) | −1.14883E−04 | −6.18581E−05 |
| C(5, 0) | 0.00000E+00 | 0.00000E+00 |
| C(4, 1) | 9.84342E−06 | 1.51965E−06 |
| C(3, 2) | 0.00000E+00 | 0.00000E+00 |
| C(2, 3) | 2.00854E−05 | 8.53970E−07 |
| C(1, 4) | 0.00000E+00 | 0.00000E+00 |
| C(0, 5) | 5.80457E−06 | 1.75646E−06 |
| C(6, 0) | 2.28697E−07 | −1.59897E−07 |
| C(5, 1) | 0.00000E+00 | 0.00000E+00 |
| C(4, 2) | −1.08038E−07 | −2.10394E−08 |
| C(3, 3) | 0.00000E+00 | 0.00000E+00 |
| C(2, 4) | −6.20375E−07 | 2.24671E−07 |
| C(1, 5) | 0.00000E+00 | 0.00000E+00 |
| C(0, 6) | 5.31073E−09 | −4.73714E−08 |
| C(7, 0) | 0.00000E+00 | 0.00000E+00 |
| C(6, 1) | −1.18958E−08 | 2.19596E−08 |
| C(5, 2) | 0.00000E+00 | 0.00000E+00 |
| C(4, 3) | −1.21747E−08 | −6.37039E−09 |
| C(3, 4) | 0.00000E+00 | 0.00000E+00 |
| C(2, 5) | 1.42249E−08 | −4.56950E−09 |
| C(1, 6) | 0.00000E+00 | 0.00000E+00 |
| C(0, 7) | −8.70317E−09 | −5.48091E−09 |

TABLE 8B
Example 3

| Sn | 1, 7 | 2, 4, 6 |
|---|---|---|
| C(8, 0) | 2.33448E−10 | 9.83848E−10 |
| C(7, 1) | 0.00000E+00 | 0.00000E+00 |
| C(6, 2) | 1.98084E−09 | 1.39404E−09 |
| C(5, 3) | 0.00000E+00 | 0.00000E+00 |
| C(4, 4) | 1.07304E−11 | 1.38956E−09 |
| C(3, 5) | 0.00000E+00 | 0.00000E+00 |
| C(2, 6) | −5.06816E−10 | 6.70261E−10 |
| C(1, 7) | 0.00000E+00 | 0.00000E+00 |
| C(0, 8) | −2.55817E−13 | 4.49973E−10 |
| C(9, 0) | 0.00000E+00 | 0.00000E+00 |
| C(8, 1) | −3.02824E−11 | −9.80270E−11 |
| C(7, 2) | 0.00000E+00 | 0.00000E+00 |
| C(6, 3) | −7.01044E−11 | −1.03906E−10 |
| C(5, 4) | 0.00000E+00 | 0.00000E+00 |
| C(4, 5) | 1.39135E−11 | 1.82299E−11 |
| C(3, 6) | 0.00000E+00 | 0.00000E+00 |
| C(2, 7) | −9.09087E−12 | 4.08661E−12 |
| C(1, 8) | 0.00000E+00 | 0.00000E+00 |
| C(0, 9) | 3.91482E−12 | 1.34299E−12 |
| C(10, 0) | −5.41433E−13 | −1.00239E−12 |
| C(9, 1) | 0.00000E+00 | 0.00000E+00 |
| C(8, 2) | −1.92342E−12 | 9.22424E−13 |
| C(7, 3) | 0.00000E+00 | 0.00000E+00 |
| C(6, 4) | −3.44480E−12 | −6.54766E−12 |
| C(5, 5) | 0.00000E+00 | 0.00000E+00 |
| C(4, 6) | 6.85564E−13 | −3.94265E−12 |
| C(3, 7) | 0.00000E+00 | 0.00000E+00 |
| C(2, 8) | 4.49933E−13 | −2.78783E−12 |
| C(1, 9) | 0.00000E+00 | 0.00000E+00 |
| C(0, 10) | −5.33858E−14 | −8.09888E−13 |

TABLE 9
Example 3

| Sn | 3, 5 | 14 | 15 |
|---|---|---|---|
| KA | 8.45315E−01 | 1.00000E+00 | 1.00000E+00 |
| A3 | 0.00000E+00 | 0.00000E+00 | 0.00000E+00 |
| A4 | −2.51914E−05 | −2.91485E−04 | 5.88876E−04 |
| A5 | 4.08210E−06 | −3.80576E−05 | −1.05825E−04 |
| A6 | 1.67940E−07 | 2.12756E−05 | 3.43699E−05 |
| A7 | −7.06931E−08 | −5.54849E−06 | −4.05371E−06 |
| A8 | 4.70091E−10 | 2.53540E−07 | −6.03705E−07 |
| A9 | 4.57195E−10 | 9.67182E−08 | 2.02235E−07 |
| A10 | −8.52496E−12 | −1.09265E−08 | −1.34344E−08 |
| A11 | −1.71591E−12 | | |
| A12 | 4.53257E−14 | | |
| A13 | 3.32047E−15 | | |
| A14 | −1.04810E−16 | | |
| A15 | −2.59355E−18 | | |
| A16 | 9.07739E−20 | | |

### Example 4

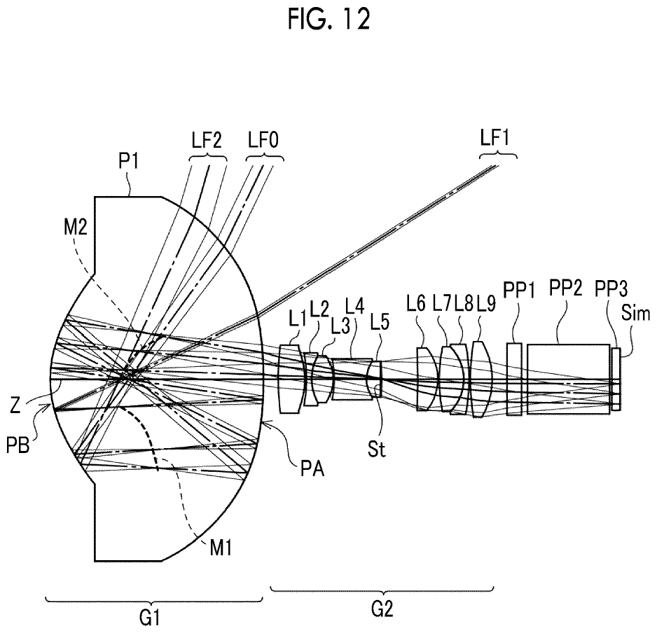

FIG. 12 shows a cross-sectional view of a configuration of the imaging optical system of Example 4 and a luminous flux. The imaging optical system according to Example 4 consists of a first optical system G1 and a second optical system G2 along the optical path in order from the magnification side to the reduction side. The first optical system G1 consists of an optical member P1. The second optical system G2 consists of lenses L1 to L5, an aperture stop St, and lenses L6 to L9 in order from the magnification side to the reduction side. Intermediate images M1 and M2 are formed inside the first optical system G1.

A size of the display surface Sim is the same as that in Example 1. A position of a center (grid point S) of the display surface Sim is at coordinates (X, Y)=(0, −2.1) in an XY coordinate system in which the virtual optical axis Zv is an origin (unit: millimeters (mm)).

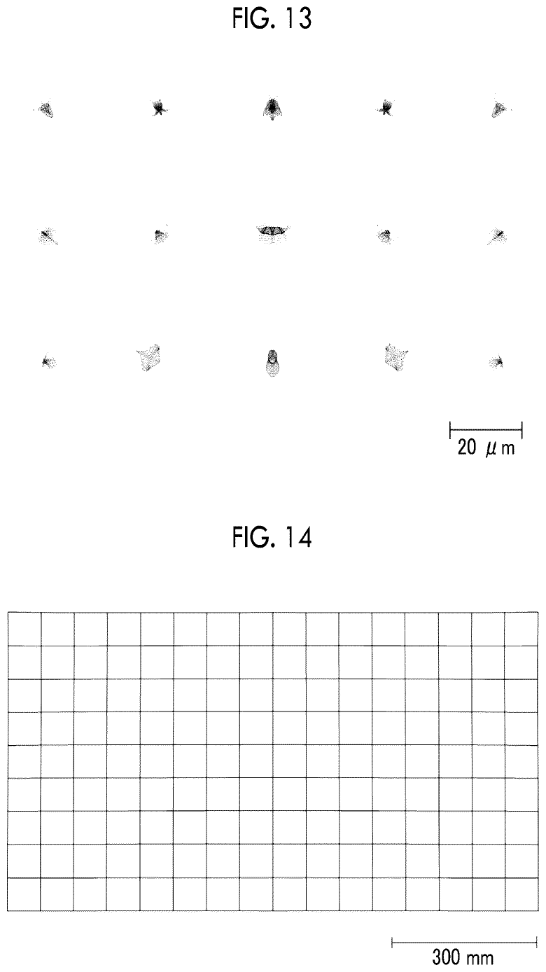

For the imaging optical system of Example 4, basic lens data is shown in Table 10, aspherical coefficients are shown in Table 11, the spot diagram is shown in FIG. 13, and the distortion grid is shown in FIG. 14.

TABLE 10
Example 4

| Sn | R | D | Nd | νd | |
|---|---|---|---|---|---|
| *1(PA) | −61.9307 | −28.9998 | 1.51680 | 64.197 | |
| *2(PB) | 17.1617 | 28.9998 | 1.51680 | 64.197 | Reflective surface |
| *3(PA) | −61.9307 | −28.9998 | 1.51680 | 64.197 | Reflective surface |
| *4(PB) | 17.1617 | 28.9998 | 1.51680 | 64.197 | Reflective surface |
| *5(PA) | −61.9307 | 1.9991 | | | |
| 6 | 40.2139 | 3.6430 | 1.68948 | 31.023 | |
| *7 | −9.6092 | 0.2059 | | | |
| 8 | −21.9907 | 0.6995 | 1.90043 | 37.372 | |
| 9 | 7.2017 | 2.8427 | 1.51742 | 52.430 | |
| 10 | −6.8944 | 0.1498 | | | |
| 11 | −14.9433 | 4.3955 | 1.90043 | 37.372 | |
| 12 | 4.6400 | 2.0604 | 1.71736 | 29.518 | |
| 13 | −49.1893 | −0.1513 | | | |
| 14(St) | ∞ | 5.0608 | | | |
| 15 | −115.8677 | 2.7469 | 1.54814 | 45.784 | |
| 16 | −7.3446 | 0.2002 | | | |
| 17 | 25.0433 | 3.3167 | 1.49700 | 81.607 | |
| 18 | −6.8683 | 0.6951 | 1.95375 | 32.318 | |
| 19 | −28.4671 | 0.2001 | | | |
| 20 | 33.7783 | 2.9682 | 1.49700 | 81.607 | |
| 21 | −11.198 | 2.0000 | | | |
| 22 | ∞ | 2.0000 | 1.51680 | 64.197 | |
| 23 | ∞ | 0.8000 | | | |
| 24 | ∞ | 11.2000 | 1.72342 | 37.955 | |
| 25 | ∞ | 0.3000 | | | |
| 26 | ∞ | 1.1000 | 1.48749 | 70.440 | |
| 27 | ∞ | 0.0196 | | | |

Projection distance (mm) 192
Overall angle of view (degree) 155
Stop diameter (mm) 2.55

TABLE 11
Example 4

| Sn | 1, 3, 5 | 2, 4 | 7 |
|---|---|---|---|
| KA | 4.97658E+00 | 8.18076E−01 | 1.00000E+00 |
| A3 | −1.78559E−04 | 4.50870E−04 | 0.00000E+00 |
| A4 | −1.37195E−06 | −2.58906E−04 | 1.08624E−03 |
| A5 | 1.66949E−06 | 2.69715E−05 | −2.46210E−04 |
| A6 | −2.06628E−07 | 4.90373E−06 | 4.29638E−05 |
| A7 | −6.24993E−09 | −1.05132E−06 | 4.05932E−06 |
| A8 | 1.07509E−09 | −1.41786E−08 | −2.53059E−06 |
| A9 | 7.53749E−12 | 1.27232E−08 | 2.60503E−07 |
| A10 | −2.60872E−12 | −3.24479E−10 | −1.98198E−10 |
| A11 | 7.44430E−15 | −7.46976E−11 | |
| A12 | 3.25483E−15 | 3.30403E−12 | |
| A13 | −2.46396E−17 | 2.14429E−13 | |
| A14 | −1.89439E−18 | −1.19033E−14 | |
| A15 | 1.52807E−20 | −2.41176E−16 | |
| A16 | 3.38168E−22 | 1.52752E−17 | |

Table 12 shows the corresponding values of Conditional Expressions (1) and (2) regarding the imaging optical systems according to Examples 1 to 4.

TABLE 12

| Expression | Conditional | Exam- | Exam- | Exam- | Exam- |
|---|---|---|---|---|---|
| No. | Expression | ple 1 | ple 2 | ple 3 | ple 4 |
| (1) | \|L1/L2\| | 0.49 | 0.54 | 0.59 | 0.48 |
| (2) | \|L3/L4\| | 0.49 | 0.54 | 0.59 | 0.48 |

The imaging optical systems of Examples 1 to 4 are configured to be small with a small number of optical elements, and each aberration is favorably corrected to achieve high optical performance. In addition, the overall angle of view is greater than 130 degrees, and the imaging optical system has a wide angle of view.

Next, a projection type display device according to an embodiment of the present disclosure will be described. FIG. 15 is a schematic configuration diagram showing the projection type display device according to an embodiment of the present disclosure. The projection type display device 100 shown in FIG. 15 has the imaging optical system 10 according to the embodiment of the present disclosure, a light source 15, transmissive display elements 11a to 11c as light valves each corresponding to each color light, dichroic mirrors 12 and 13 for color separation, a cross dichroic prism 14 for color synthesis, condenser lenses 16a to 16c, and total reflection mirrors 18a to 18c that deflect the optical path. In addition, FIG. 15 schematically shows the imaging optical system 10. Further, an integrator is disposed between the light source 15 and the dichroic mirror 12, but is not shown in FIG. 15.

White light emitted from the light source 15 is separated into three colored luminous fluxes (green light, blue light, and red light) through the dichroic mirrors 12 and 13. Next, the three colored luminous fluxes pass through the condenser lenses 16a to 16c, are incident into and modulated by the transmissive display elements 11a to 11c respectively corresponding to the respective colored luminous fluxes, are subjected to color synthesis by the cross dichroic prism 14, and are subsequently incident into the imaging optical system 10. The imaging optical system 10 projects an optical image, which is formed by the light modulated through the transmissive display elements 11a to 11c, onto a screen 105.

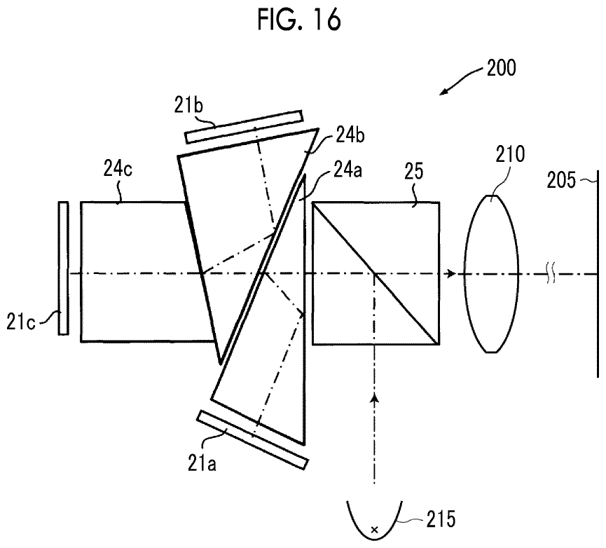

FIG. 16 is a schematic configuration diagram showing a projection type display device according to another embodiment of the present disclosure. A projection type display device 200 shown in FIG. 16 includes an imaging optical system 210 according to the embodiment of the present disclosure, a light source 215, DMD elements 21a to 21c as light valves corresponding to each color light, total internal reflection (TIR) prisms 24a to 24c for color decomposition and color synthesis, and a polarization separating prism 25 that separates illumination light and projection light. In addition, FIG. 16 schematically shows the imaging optical system 210. Further, an integrator is disposed between the light source 215 and the polarization separating prism 25, but is not shown in FIG. 16.

White light emitted from the light source 215 is reflected from a reflective surface inside the polarization separating prism 25, and is separated into three colored luminous fluxes (green light, blue light, and red light) by the TIR prisms 24a to 24c. The separated colored luminous fluxes with the respective colors are respectively incident into and modulated through the corresponding DMD elements 21a to 21c, travel through the TIR prisms 24a to 24c again in a reverse direction, are subjected to color synthesis, are subsequently transmitted through the polarization separating prism 25, and are incident into the imaging optical system 210. The imaging optical system 210 projects an optical image, which is formed by the light modulated through the DMD elements 21a to 21c, onto a screen 205.

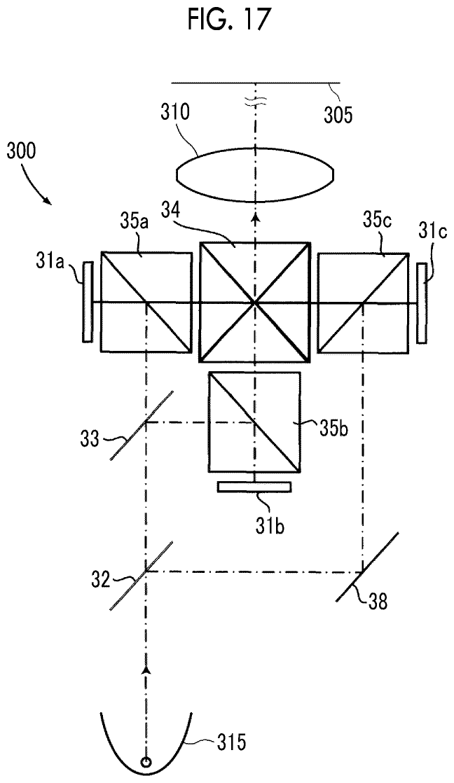

FIG. 17 is a schematic configuration diagram showing a projection type display device according to still another embodiment of the present disclosure. A projection type display device 300 shown in FIG. 17 includes an imaging optical system 310 according to the embodiment of the present disclosure, a light source 315, reflective display elements 31a to 31c as light valves each corresponding to each color light, dichroic mirrors 32 and 33 for color separation, a cross dichroic prism 34 for color synthesis, a total reflection mirror 38 for deflecting the optical path, and polarization separating prisms 35a to 35c. In addition, FIG. 17 schematically shows the imaging optical system 310. Further, an integrator is disposed between the light source 315 and the dichroic mirror 32, but is not shown in FIG. 17.

White light emitted from the light source 315 is separated into three colored luminous fluxes (green light, blue light, and red light) through the dichroic mirrors 32 and 33. The separated colored luminous fluxes with the respective colors respectively pass through the polarization separating prisms 35a to 35c, are incident into and modulated through the reflective display elements 31a to 31c respectively corresponding to the ray with the respective colors, are subjected to color synthesis through the cross dichroic prism 34, and are subsequently incident into the imaging optical system 310. The imaging optical system 310 projects an optical image, which is formed by the light modulated through the reflective display elements 31a to 31c, onto a screen 305.

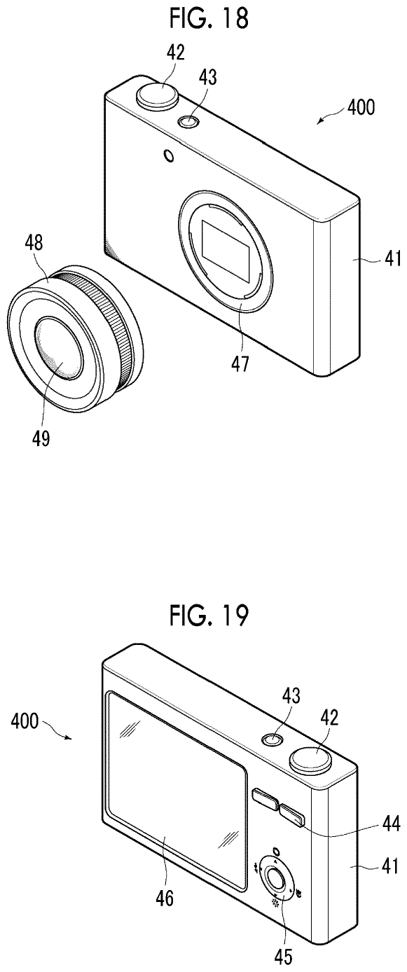

FIGS. 18 and 19 are external views showing a camera 400 that is an imaging apparatus according to an embodiment of the present disclosure. FIG. 18 is a perspective view showing the camera 400 in a view from the front side, and FIG. 19 is a perspective view showing the camera 400 in a view from the rear side. The camera 400 is a single-lens digital camera on which an interchangeable lens 48 is attachably and detachably mounted and which has no reflex finder. The interchangeable lens 48 is configured such that an imaging optical system 49 as the optical system according to the embodiment of the present disclosure is housed in a lens barrel.

The camera 400 includes a camera body 41, and a shutter button 42 and a power button 43 are provided on an upper surface of the camera body 41. Further, an operator 44, an operator 45 and a display unit 46 are provided on the rear surface of the camera body 41. The display unit 46 displays a captured image and an image within an angle of view before imaging.

An imaging aperture through which light from an imaging target is incident is provided at the center on the front surface of the camera body 41. A mount 47 is provided at a position corresponding to the imaging aperture. The interchangeable lens 48 is mounted on the camera body 41 with the mount 47 interposed therebetween.

In the camera body 41, there are provided an imaging element (not shown in the drawing), a signal processing circuit (not shown in the drawing), a storage medium (not shown in the drawing), and the like. The imaging element such as a charge coupled device (CCD) or a complementary metal oxide semiconductor (CMOS) outputs a captured image signal based on a subject image which is formed through the interchangeable lens 48. The signal processing circuit generates an image through processing of the captured image signal which is output from the imaging element. The storage medium stores the generated image. The camera 400 captures a still image or a motion picture by pressing the shutter button 42, and records image data obtained through imaging in the recording medium.

While the disclosed technology has been described above with the embodiment and the examples, the disclosed technology is not limited to the embodiment and the examples and can be subjected to various modifications. For example, the curvature radii, surface intervals, refractive indices, Abbe numbers, free curved surface coefficients, and aspherical coefficients of each lens and optical member are not limited to the values shown in the examples, and other values can be used.

Further, the projection type display device according to the present disclosed technology is not limited to the above-described configuration, and may be modified into various forms such as the optical member used for luminous flux separation or luminous flux synthesis and the light valve. The light valve is not limited to a form in which light emitted from the light source is spatially modulated by an image display element and is output as an optical image based on image data, but may be a form in which light itself output from a light emitting image display element is output as an optical image based on the image data. Examples of the light emitting image display element include an image display element where light emitting elements such as light emitting diodes (LED) or organic light emitting diodes (OLED) are two-dimensionally arranged.

Further, the imaging apparatus according to the technology of the present disclosure is not limited to the above configuration, and may be modified into various forms such as a camera other than a non-reflex system, a film camera, a video camera, and a camera for movie imaging.

The following appendices are further disclosed with respect to the embodiment and the examples described above.

### [Supplementary Note 1]

An imaging optical system consisting of a first optical system and a second optical system along an optical path in order from a magnification side to a reduction side,
in which an intermediate image is formed at least twice between a magnification-side imaging plane and a reduction-side imaging plane,
the first optical system includes at least two reflective surfaces having curvature,
a surface of the first optical system on a most magnification side along the optical path is a first refractive surface that refracts rays reflected from the reflective surface of the first optical system, and
a surface of the first optical system on a most reduction side along the optical path is a surface on the most reduction side along the optical path among surfaces through which rays pass a plurality of times.

### [Supplementary Note 2]

The imaging optical system according to Supplementary Note 1,
in which in a case where a distance on an optical axis from the first refractive surface to a reflective surface of the first optical system on the most magnification side along the optical path is denoted by L1, and a distance on the optical axis from the reflective surface of the first optical system on the most magnification side along the optical path to a surface of the second optical system on the most reduction side along the optical path is denoted by L2, Conditional Expression (1) is satisfied,

$$0 \text{.1} < \vert L 1 / L 2 \vert < 0.8 . \qquad ( 1 )$$

### [Supplementary Note 3]

The imaging optical system according to Supplementary Note 1 or 2,
in which in a case where a distance on the optical axis from the first refractive surface to a reflective surface of the first optical system on the most reduction side along the optical path is denoted by L3, and a distance on the optical axis from the reflective surface of the first optical system on the most reduction side along the optical path to a surface of the second optical system on the most reduction side along the optical path is denoted by L4, Conditional Expression (2) is satisfied,

$$0 \text{.1} < \vert L 3 / L 4 \vert < 0. 8 . \qquad ( 2 )$$

### [Supplementary Note 4]

The imaging optical system according to any one of Supplementary Notes 1 to 3,
in which, inside the first optical system, rays are reflected three times from the reflective surface having curvature.

### [Supplementary Note 5]

The imaging optical system according to any one of Supplementary Notes 1 to 4, in which the reflective surface of the first optical system on the most magnification side along the optical path and the reflective surface of the first optical system on the most reduction side along the optical path have a concave shape.

### [Supplementary Note 6]

The imaging optical system according to any one of Supplementary Notes 1 to 5, in which the intermediate image is formed twice inside the first optical system.

### [Supplementary Note 7]

The imaging optical system according to any one of Supplementary Notes 1 to 6, in which the first refractive surface has a free curved surface shape.

### [Supplementary Note 8]

The imaging optical system according to any one of Supplementary Notes 1 to 7, including:
a display element or an imaging element disposed on the reduction-side imaging plane,
in which at least one of an optical axis of the first optical system or an optical axis of the second optical system is shifted in a direction orthogonal to the optical axis with respect to a center of the display element or the imaging element.

### [Supplementary Note 9]

The imaging optical system according to Supplementary Note 8, in which the optical axis of the first optical system is shifted in the direction orthogonal to the optical axis with respect to each of the optical axis of the second optical system and the center of the display element or the imaging element, and
the optical axis of the second optical system is shifted in the direction orthogonal to the optical axis with respect to the center of the display element or the imaging element.

### [Supplementary Note 10]

The imaging optical system according to any one of Supplementary Notes 1 to 9, in which the first refractive surface transmits rays twice.

### [Supplementary Note 11]

The imaging optical system according to any one of Supplementary Notes 1 to 10, in which the first refractive surface and one of the reflective surfaces are formed on the same optical member.

### [Supplementary Note 12]

The imaging optical system according to any one of Supplementary Notes 1 to 11, in which the first optical system consists of one optical member.

### [Supplementary Note 13]

The imaging optical system according to Supplementary Note 12,
in which the optical member includes
   the first refractive surface that transmits rays twice and reflects rays once, and
   a surface facing the first refractive surface and that reflects rays twice.

### [Supplementary Note 14]

The imaging optical system according to any one of Supplementary Notes 1 to 13, in which the reflective surface of the first optical system on the most magnification side along the optical path and the reflective surface of the first optical system on the most reduction side along the optical path are formed on the same surface.

### [Supplementary Note 15]

The imaging optical system according to Supplementary Note 2,
in which Conditional Expression (1-1) is satisfied,

$$0.2 < \vert L 1 / L 2 \vert < 0.7 . \qquad ( 1 ‐ 1 )$$

### [Supplementary Note 16]

The imaging optical system according to Supplementary Note 3,
in which Conditional Expression (2-1) is satisfied,

$$0.2 < \vert L 3 / L 4 \vert < 0.7 . \qquad ( 2 ‐ 1 )$$

### [Supplementary Note 17]

An imaging optical system,
wherein an optical member disposed on a most magnification side along an optical path,
an intermediate image is formed at least twice between a magnification-side imaging plane and a reduction-side imaging plane, and
the optical member includes
   a PA surface that is a surface on the most magnification side along the optical path and that transmits rays twice and reflects rays once, and
   a PB surface that is a surface facing the PA surface and that reflects rays twice.

### [Supplementary Note 18]

The imaging optical system according to Supplementary Note 17,
in which the intermediate image is formed twice inside the optical member.

### [Supplementary Note 19]

A projection type display device comprising:
the imaging optical system according to any one of Supplementary Notes 1 to 18.

### [Supplementary Note 20]

An imaging apparatus comprising:
the imaging optical system according to any one of Supplementary Notes 1 to 18.

The disclosure of JP2023-116335 filed on Jul. 14, 2023 is incorporated herein by reference in its entirety. All of the documents, the patent applications, and the technical standards described in the present specification are incorporated into the present specification by reference to the same extent as in a case in which each of the documents, the patent applications, and the technical standards are specifically and individually stated to be described by reference.

What is claimed is:

1. An imaging optical system consisting of a first optical system and a second optical system along an optical path in order from a magnification side to a reduction side, wherein:
an intermediate image is formed at least twice between a magnification-side imaging plane and a reduction-side imaging plane,
the first optical system includes at least two reflective surfaces having curvature,
a surface of the first optical system on a most magnification side along the optical path is a first refractive surface that refracts rays reflected from the reflective surface of the first optical system,
the first refractive surface that transmits rays twice and reflects rays once,
the first refractive surface is a surface on which a surface that transmits rays twice and a surface that reflects rays once are formed on the same surface, and
a surface of the first optical system on a most reduction side along the optical path is a surface on the most reduction side along the optical path among surfaces through which rays pass a plurality of times.

2. The imaging optical system according to claim 1, wherein, on the first refractive surface, respective regions that transmit rays twice and a region that reflects rays once are regions different from each other.

3. The imaging optical system according to claim 1, wherein in a case where:
a distance on an optical axis from the first refractive surface to a reflective surface of the first optical system on the most magnification side along the optical path is denoted by L1, and
a distance on the optical axis from the reflective surface of the first optical system on the most magnification side along the optical path to a surface of the second optical system on the most reduction side along the optical path is denoted by L2,
Conditional Expression (1) is satisfied,
$$0 \text{.1} < \vert L 1 / L 2 \vert < 0.8 . \qquad ( 1 )$$

4. The imaging optical system according to claim 3, wherein in a case where:
a distance on the optical axis from the first refractive surface to a reflective surface of the first optical system on the most reduction side along the optical path is denoted by L3, and
a distance on the optical axis from the reflective surface of the first optical system on the most reduction side along the optical path to a surface of the second optical system on the most reduction side along the optical path is denoted by L4,
Conditional Expression (2) is satisfied,
$$0 \text{.1} < \vert L 3 / L 4 \vert < 0.8 . \qquad ( 2 )$$

5. The imaging optical system according to claim 4, wherein, inside the first optical system, rays are reflected three times from the reflective surface having curvature.

6. The imaging optical system according to claim 5, wherein the reflective surface of the first optical system on the most magnification side along the optical path and the reflective surface of the first optical system on the most reduction side along the optical path have a concave shape.

7. The imaging optical system according to claim 1, wherein the intermediate image is formed twice inside the first optical system.

8. The imaging optical system according to claim 1, wherein the first refractive surface has a free curved surface shape.

9. The imaging optical system according to claim 1, comprising a display element or an imaging element disposed on the reduction-side imaging plane, wherein:
at least one of an optical axis of the first optical system or an optical axis of the second optical system is shifted in a direction orthogonal to the optical axis with respect to a center of the display element or the imaging element.

10. The imaging optical system according to claim 9, wherein:
the optical axis of the first optical system is shifted in the direction orthogonal to the optical axis with respect to each of the optical axis of the second optical system and the center of the display element or the imaging element, and
the optical axis of the second optical system is shifted in the direction orthogonal to the optical axis with respect to the center of the display element or the imaging element.

11. The imaging optical system according to claim 1, wherein the first refractive surface and one of the reflective surfaces are formed on the same optical member.

12. The imaging optical system according to claim 1, wherein the first optical system consists of one optical member.

13. The imaging optical system according to claim 12, wherein the optical member includes a surface facing the first refractive surface and that reflects rays twice.

14. The imaging optical system according to claim 12, wherein the reflective surface of the first optical system on the most magnification side along the optical path and the reflective surface of the first optical system on the most reduction side along the optical path are formed on the same surface.

15. The imaging optical system according to claim 3, wherein Conditional Expression (1-1) is satisfied,
$$0.2 < \vert L 1 / L 2 \vert < 0.7 . \qquad ( 1 ‐ 1 )$$

16. The imaging optical system according to claim 4, wherein Conditional Expression (2-1) is satisfied,
$$0.2 < \vert L 3 / L 4 \vert < 0.7 . \qquad ( 2 ‐ 1 )$$

17. An imaging optical system, wherein:
an intermediate image is formed at least twice between a magnification-side imaging plane and a reduction-side imaging plane,
an optical member disposed on a most magnification side along an optical path includes:
a PA surface that is a surface on the most magnification side along the optical path and that transmits rays twice and reflects rays once; and
a PB surface that is a surface facing the PA surface and that reflects rays twice, and
the PA surface is a surface on which a surface that transmits rays twice and a surface that reflects rays once are formed on the same surface.

18. The imaging optical system according to claim 17, wherein the intermediate image is formed twice inside the optical member.

19. A projection type display device comprising the imaging optical system according to claim 1.

20. An imaging apparatus comprising the imaging optical system according to claim 1.
